(19) United States
(12) Patent Application Publication
(10) Pub. No.: US 2021/0182696 A1
(43) Pub. Date: Jun. 17, 2021

(54) PREDICTION OF OBJECTIVE VARIABLE USING MODELS BASED ON RELEVANCE OF EACH MODEL

(71) Applicant: INTERNATIONAL BUSINESS MACHINES CORPORATION, Armonk, NY (US)

(72) Inventors: Tetsuro Morimura, Tokyo (JP); Takashi Yonezawa, Kanagawa-ken (JP); Takehiko Yasukawa, Tokyo (JP)

(21) Appl. No.: 16/710,576

(22) Filed: Dec. 11, 2019

(51) Int. Cl. G06N 5/04; G06N 20/00

(52) U.S. Cl. CPC G06N 5/04; G06N 20/00

(57) ABSTRACT

It is preferable to predict an objective variable by optimally selecting or combining the output of a plurality of models. A computer-implemented method is provided that calculates, for each of a plurality of models, a relevance of an output of the model with respect to a value of an objective variable based on the value of the objective variable and the output of the model in the past. The method also calculates, for each of the plurality of models, similarities between a current timing and a plurality of past timings based on the output of the model at the current timing, the output of the model at the plurality of past timings, and the relevance. Additionally, the method predicts the value of the objective variable at a target timing based on the similarities.

### BACKGROUND

The present invention relates to prediction of objective variables using a plurality of models, more specifically to the prediction of objective variables using a plurality of models based on the relevance of each model to a value of an objective variable.

When using a plurality of models to predict an objective variable, it is confusing to simply provide a user with the outputs of all of the models. There is a desire to predict the value of an objective variable by optimally selecting or combining the outputs of a plurality of models.

### SUMMARY

According to an embodiment of the present invention, a computer-implemented method is provided that includes calculating, for each of a plurality of models, a relevance of an output of the model with respect to a value of an objective variable based on the value of the objective variable and the output of the model in the past The method also calculates, for each of the plurality of models, similarities between a current timing and a plurality of past timings based on the output of the model at the current timing, the output of the model at the plurality of past timings, and the relevance. Additionally, the method predicts the value of the objective variable at a target timing based on the similarities. In this way, it is possible to predict the value of the objective variable while taking into consideration the relevance of the output of each model with respect to the value of the objective variable.

Calculating the similarities can include, for each model, calculating the similarities based on distances between the output of the model at the current timing and the output of the model at the plurality of past timings. In this way, for each model, it is possible to calculate the similarities using the distances between the output of the model at the current timing and the output of the model at the plurality of past timings.

Calculating the relevance can include, for each model, extracting a plurality of timings at which the output of the model is similar to the output of the model at a predetermined timing in the past; calculating the likelihood of the model given a value of the objective variable at the predetermined timing, based on a distribution of values of the objective variable at the plurality of timings; and calculating the relevance based on the likelihood. In this way, it is possible to calculate the relevance using the likelihood of the model given the value of the objective variable at a predetermined timing in the past.

Predicting the value of the objective variable can include generating a predicted distribution of the value of the objective variable at the target timing. In this way, it is possible to obtain the predicted distribution of the value of the objective variable at the target timing.

Calculating the similarities can include weighting the similarities according to differences between the current timing and the plurality of past timings. In this way, it is possible to calculate the similarities that are weighted according to the differences between the current timing and the plurality of past timings.

According to another embodiment of the present invention, an apparatus is provided that includes a processor or a programmable circuitry, and one or more computer readable mediums collectively including instructions that, in response to being executed by the processor or the programmable circuitry, cause the processor or the programmable circuitry to calculate, for each of a plurality of models, a relevance of an output of the model with respect to a value of an objective variable based on the value of the objective variable and the output of the model in the past. The instructions also cause the processor to calculate, for each of the plurality of models, similarities between a current timing and a plurality of past timings based on the output of the model at the current timing, the output of the model at the plurality of past timings, and the relevance. In addition, the instructions cause the processor to predict the value of the objective variable at a target timing, based on the similarities. In this way, it is possible to predict the value of the objective variable while taking into consideration the relevance of the output of each model with respect to the value of the objective variable.

According to another embodiment of the present invention, a computer program product is provided that includes one or more computer readable storage mediums collectively storing program instructions that are executable by a processor or programmable circuitry to cause the processor or the programmable circuitry to perform operations including calculating, for each of a plurality of models, a relevance of an output of the model with respect to a value of an objective variable based on the value of the objective variable and the output of the model in the past. The instructions also cause the processor to calculate, for each of the plurality of models, similarities between a current timing and a plurality of past timings based on the output of the model at the current timing, the output of the model at the plurality of past timings, and the relevance. Additionally, the instructions cause the processor to predicting the value of the objective variable at a target timing, based on the similarities. In this way, it is possible to predict the value of the objective variable while taking into consideration the relevance of the output of each model with respect to the value of the objective variable.

The summary clause does not necessarily describe all necessary features of the embodiments of the present invention. The present invention can also be a sub-combination of the features described above. The above and other features and advantages of the present invention will become more apparent from the following description of the embodiments taken in conjunction with the accompanying drawings.

### BRIEF DESCRIPTION OF THE DRAWINGS

The following description will provide details of preferred embodiments with reference to the following figures wherein:

FIG. 1 shows an example of a block diagram of an apparatus 100 according to an embodiment of the present embodiment.

FIG. 2 shows examples of the outputs of each model and the values of the objective variables associated with the timings T according to an embodiment of the present invention.

FIG. 3 shows an example of the flow by which the apparatus 100, according to an embodiment of the present invention, predicts the value of the objective variable.

FIG. 4 shows examples of the predicted distribution and the histogram of the 10-day return generated by the apparatus 100 according to an embodiment of the present invention.

FIG. 5 shows an example of a block diagram of the apparatus 100 according to an embodiment of the present invention.

FIG. 6 shows an example of a flow by which the apparatus 100, according to an embodiment of the present invention, calculates a 5% tail risk of the 10-day return, as an indicator of the generated predicted distribution of the value of the objective variable.

FIG. 7 shows examples of a reference distribution and a predicted distribution of the 10-day return generated by the apparatus 100 according to an embodiment of the present invention.

FIG. 8 shows an exemplary hardware configuration of a computer configured to perform the foregoing operations, according to an embodiment of the present invention.

### DETAILED DESCRIPTION

Hereinafter, some embodiments of the present invention will be described. The embodiments do not limit the invention according to the claims, and all the combinations of the features described in the embodiments are not necessarily essential to means provided by aspects of the invention.

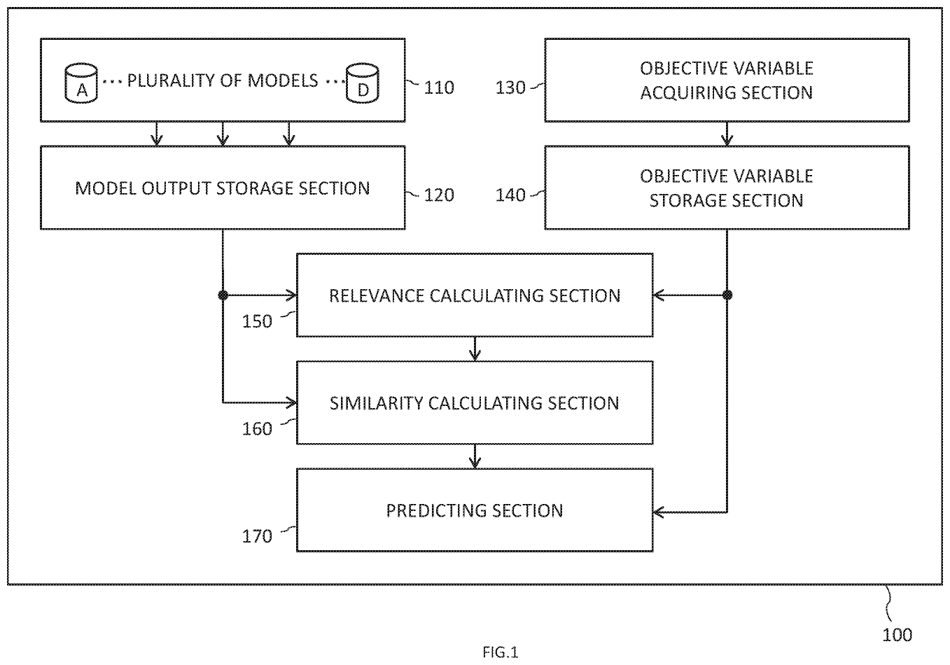

FIG. 1 shows an example of a block diagram of an apparatus 100 according to the present embodiment. The apparatus 100 can be a computer such as a PC (Personal Computer), a tablet computer, a smart phone, a work station, a server computer, a general use computer, or can be a computer system in which a plurality of computers are connected. Such a computer system is considered to be a computer in a broad sense. The apparatus 100 can be realized by one or more virtual computer environments that can be executed in a computer. Instead, the apparatus 100 can be a specialized computer designed to predict objective variables, or can be specialized hardware realized by specialized circuitry. If the apparatus 100 is capable of connecting to the Internet, the apparatus 100 can be realized by cloud computing.

The apparatus 100 predicts an objective variable using a plurality of models 110. At this time, the apparatus 100 considers the relevance of the output of each model with respect to the value of the objective variable, when predicting the value of the objective variable. The following describes an example in which the apparatus 100 predicts a 10-day return as the objective variable, using prediction results of a plurality of financial models. Here, the return indicates the rate of return obtained by dividing the return on investment divided by the investment principal, and the apparatus 100 predicts the 10-day return that is a value occurring after 10 days, for example. However, the apparatus 100 is not limited to this. The apparatus 100 can estimate other objective variables related to finance, such as volatility indicating the degree of price fluctuation, for example, using a plurality of financial models. Furthermore, the apparatus 100 can predict any objective variable that is not related to finance, using any types of models that are not financial models. It is noteworthy that embodiments can be configured to use models relating to healthcare, image recognition, speech recognition, etc. to predict objective variables related to those respective fields. Thus, the models can be any representations of real world environments and scenarios.

For example, a plurality of models representing the progression of an illness in response to different treatments can be used in some embodiments such that the apparatus 100 predicts a treatment outcome as the objective variable using the prediction results of the plurality of treatment models for the illness. The objective variable can be used to identify a preferred treatment to be administered by a physician.

In another example, a plurality of speech recognition models can be used in some embodiments such that the apparatus 100 identify words or phrases as being included in an analyzed portion of speech as the objective value using the prediction results of the plurality of speech recognition models. The objective variable generated by a speech recognition embodiment can be used to determine a reply to output by way of a speaker or an action to perform.

The apparatus 100 includes a plurality of models 110, a model output storage section 120, a target variable acquiring section 130, a target variable storage section 140, a relevance calculating section 150, a similarity calculating section 160, and a predicting section 170.

The plurality of models 110 each predict and output various feature values related to an objective variable that is the target, using past data. The plurality of models 110 can be any models that can output feature quantities related to the objective variable that is a target, such as regression analyses, neural networks, support vector machines, decision trees, and logit models, and the plurality of models 110 can output respectively different feature amounts. In the present embodiment, an example is described in which the plurality of models 110 output various feature values such as the return, volatility, and change point (an indicator of how different the market is than usual) that relate to a 10-day return, using various known financial models A to D. The plurality of models 110 each supply the output thereof to the model output storage section 120. In the present drawing, an example is shown in which the plurality of models 110 are provided to the apparatus 100, but the present embodiment is not limited to this. The apparatus 100 can acquire the output of a plurality of models provided to a different apparatus, and supply the acquired output of each model to the model output storage section 120.

The model output storage section 120 stores the output of each model supplied from the plurality of models 110. The model output storage section 120 stores the feature values output by each model, as time-series data associated with a timing T at which each model output the feature value. Here, the timing T can be any unit of time, such as a year, month, day, hour, and minute. In the present embodiment, an example is described in which the model output storage section 120 stores the feature value output by each model in units of days.

The target variable acquiring section 130 acquires the value of the objective variable that is the prediction target of the apparatus 100 via user input, a network, or the like. In the present embodiment, an example is described in which the target variable acquiring section 130 acquires an actual value of a 10-day return. The target variable acquiring section 130 supplies the target variable storage section 140 with the acquired value of the objective variable.

The target variable storage section 140 stores the value of the objective variable supplied from the target variable acquiring section 130. The target variable storage section 140 stores the value of the objective variable as time-series data associated with the timing T that is a reference for the value of the objective variable. The target variable storage section 140 stores the actual value of the 10-day return in day units, in the same manner as the model output storage section 120, in association with the timing T that is the reference for the 10-day return, e.g., the timing T that is 10 days before the actual value of the 10-day return was acquired.

For each of the plurality of models 110, the relevance calculating section 150 calculates the relevance of the output of the model with respect to the value of the objective variable, based on the past output of the model and values of the objective variable. As an example, the relevance calculating section 150 acquires the feature values output by each model in the past, from the model output storage section 120. Furthermore, the relevance calculating section 150 acquires the actual values of past 10-day returns from the target variable storage section 140. For each of the plurality of models 110, the relevance calculating section 150 calculates the relevance of the output of the model with respect to the value of the 10-day return, based on the feature values output by the model and the actual values of the 10-day returns in the past. The relevance calculating section 150 supplies the similarity calculating section 160 with the calculated relevance.

The similarity calculating section 160 calculates a similarity between the current timing and each of a plurality of past timings, based on the output of the model at the current timing, the output of the model at each of a plurality of past timing, and the relevance for each of the plurality of models 110. As an example, the similarity calculating section 160 acquires the feature values output by each model at the current timing and past timings, from the model output storage section 120. Furthermore, the similarity calculating section 160 acquires the relevance of the output of each model with respect to the value of the 10-day return from the relevance calculating section 150. The similarity calculating section 160 calculates the similarity between the current timing and each of the plurality of past timings, based on the feature values output at the current timing by the model, the feature values output by the model at the plurality of past timings, and the relevance for each of the plurality of models 110. The similarity calculating section 160 supplies the predicting section 170 with the calculated similarities.

The predicting section 170 predicts the value of the objective variable at the target timing, based on the similarities. As an example, the predicting section 170 acquires the similarities between the current timing and the past timings from the similarity calculating section 160. The predicting section 170 acquires the actual values of the objective variables associated with the plurality of past timings from the target variable storage section 140. The predicting section 170 predicts the value of the objective variable corresponding to the current timing, e.g., the value of the return 10 days after the current day, based on the similarities. At this time, the predicting section 170 can generate a predicted distribution of the values of the objective variable at the target timing. In other words, the predicting section 170 can generate a predicted distribution of values of the return 10 days from the current timing. The predicting section 170 outputs the predicted value of the objective variable at the target timing to another function section, another apparatus, or the like.

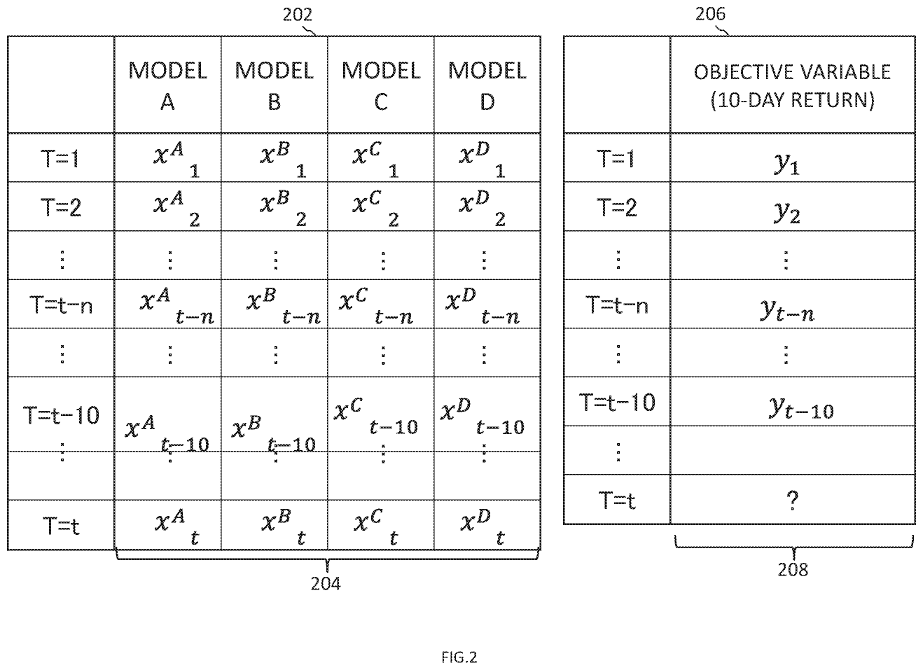

FIG. 2 shows examples of the output of each model and the values of the objective variables associated with the timings T. As an example, the model output storage section 120 stores the feature values x^{A} to x^{D} output by the models A to D 204, in association with the timings T at which each model outputs the feature value, in units of days, as shown in table 202. Here, as an example, T=1 indicates the day at which data storage begins, T=2 indicates the second day from when the data storage began, and T=t indicates the current day. Furthermore, T=t−10 indicates the day that is 10 days before the current day, and T=t−n indicates the day that is n days before the current day.

As an example, as shown in table 206 in the present drawing, the target variable storage section 140 stores the actual value of the 10-day return 208 in day units, in association with the timing that is the reference for the 10-day return, e.g., the timing that is 10 days before the day at which the actual value of the 10-day return is acquired. For example, the target variable storage section 140 stores the actual value of the 10-day return acquired at the current day T=t as the actual value yₜ₋₁₀, in association with the timing T=t−10 that is 10 days before the current day.

Here, it is possible to obtain the value yₜ of the 10-day return corresponding to the current day T=t as the actual value T=t+10 at the timing that is 10 days after the current day, but the apparatus 100 according to the present embodiment predicts the value yₜ that is 10 days later than the current day, at the current day. The following is a detailed description of this flow.

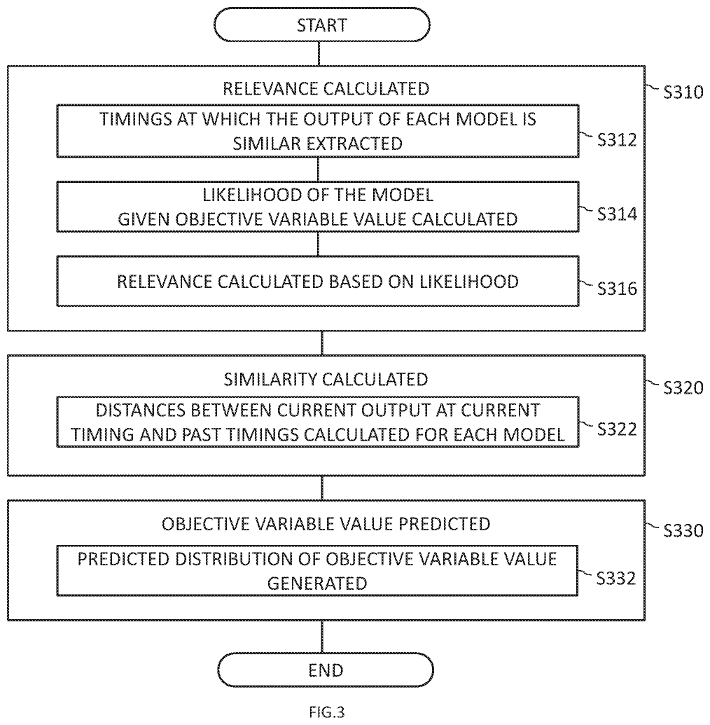

FIG. 3 shows an example of the flow by which the apparatus 100 according to the present embodiment predicts the value of the objective variable. At step 310, the apparatus 100 calculates the relevance of the output of each model with respect to the value of the objective variable, based on the outputs of the model and the values of the objective variable in the past, for each of the plurality of models 110.

At this time, as an example, at step 312, the relevance calculating section 150 extracts a plurality of timings at which the output of each model is similar to the output of this model at a predetermined timing in the past. As an example, the relevance calculating section 150 sets a predetermined past time period (e.g., 50 days) from a past timing (e.g., the timing T=t−10) at which the 10-day return was confirmed at the current timing. In other words, the relevance calculating section 150 sets a time period from the timing T=t−10 to the timing T=t−60 as a first time period. The relevance calculating section 150 then extracts, from each model, a plurality of past timings at which the output of the model is similar to the outputs x^{A}ₜ₋₁₀, x^{B}ₜ₋₁₀, x^{C}ₜ₋₁₀, and x^{D}ₜ₋₁₀ of each model at a predetermined timing (e.g., the timing T=t−10), within the first time period.

Next, at step 314, the relevance calculating section 150 calculates the likelihood of the model given the value of the objective variable at a predetermined timing, based on the distribution of the objective variable at a plurality of timings. As an example, the relevance calculating section 150 can obtain the distribution of the value y of the 10-day return at the plurality of timings in the past, in which the value y of the 10-day return corresponding to the plurality of timings in the past extracted at step S312 for each of the models is similar to the likelihood distribution. For each model, the relevance calculating section 150 calculates the likelihood of the model given the value yₜ₋₁₀ of the objective variable corresponding to the predetermined timing T=t−10, based on the obtained distribution.

At step 316, the relevance calculating section 150 calculates the relevance, based on the likelihood. At this time, the relevance calculating section 150 can calculate the relevance based on the average of logarithm of the likelihoods of the model given the value of the objective variable calculated at each of the plurality of predetermined timings. As an example, for each model, the relevance calculating section 150 acquires the likelihood Lₜ₋₁₀ at the predetermining timing T=t−10, according to step 312 and step 314. Next, for each model, the relevance calculating section 150 acquires the likelihood Lₜ₋₁₁ at another predetermined timing (e.g., T=t−11), according to step 312 and step 314. By repeating this process for all of the timings in the first time period, for example, the relevance calculating section 150 acquires the plurality of likelihoods Lₜ₋₁₀ to Lₜ₋₆₀ for each model. Then, for each model, the relevance calculating section 150 calculates the relevances R^{A} to R^{D} for each of the respective models, by calculating the logarithmic average of the plurality of likelihoods Lₜ₋₁₀ to Lₜ₋₆₀ in the first time period.

At this time, the relevance calculating section 150 can weight the logarithm of the likelihoods, according to the difference between the current timing and a predetermined timing. As an example, when calculating the average logarithmic likelihood, the relevance calculating section 150 can weight the likelihoods using an attenuation coefficient that is larger for timings closer to the current timing and smaller for timings farther from the current timing. In other words, as an example, the relevance calculating section 150 can calculate a weighted average by multiplying the likelihood Lₜ₋₁₀ calculated for the timing T=t−10 by a coefficient that is relatively larger than a coefficient by which the likelihood Lₜ₋₂₀ calculated for the timing T=t−20 is multiplied. In this way, the apparatus 100 can calculate the relevance while giving greater consideration to likelihoods calculated for timings closer to the current timing.

At step 320, for each of the plurality of models 110, the apparatus 100 calculates the similarities between the current timing and a plurality of past timings, based on the output of the model at the current timing, the output of the model at the plurality of past timings, and the relevance. At this time, the apparatus 100 can calculate the similarities based on the distances between the output of the model at the current timing and the output of the model at the plurality of past timings. Here, the distances can be Mahalanobis' distances corresponding to the relevance. This is described in detail using mathematical expressions.

As an example, the similarity calculating section 160 defines a distance measurement matrix M as shown in the expression below, using the relevances R^{A} to R^{D} calculated for the respective models by the relevance calculating section 150 in step 310. Here, β is a hyper parameter indicating the weighting degree. In other words, the similarity calculating section 160 defines the distance measurement matrix M to be a matrix obtained by weighting a diagonal matrix in which each component is the relevance of a respective model with the hyper parameter β.

$$M \text{:=} β [ \begin{matrix}{R}^{A} & & \\ & ⋱ & \\ & & {R}^{D}\end{matrix} ] , \qquad Expression 1$$

Furthermore, the similarity calculating section 160 sets a predetermined past time period (e.g., a time period up to the first day when data storage was begun) from a past timing (e.g., the timing T=t−10) at which the 10-day return is to be checked at the current timing, as a second time period. In other words, the similarity calculating section 160 sets the time period from the timing T=t−10 to the timing T=1 as the second time period. Then, at step 322, the similarity calculating section 160 calculates the distances d respectively between the output xₜ of each model at the current timing and the outputs xₜ₋ₙ of the model at a plurality of past timings (e.g., the timings T=t−n) in the second time period. In other words, the similarity calculating section 160 calculates the distances d (xₜ, xₜ₋ₙ) between the output xₜ of each model at the current timing and the output xₜ₋ₙ of the model at the plurality of past timings, as Mahalanobis' distances that take into consideration the distance measurement matrix M based on the relevance of each model.

d(xₜ,xₜ₋ₙ)=\sqrt{(xₜ−xₜ₋ₙ)^{T}M(xₜ−xₜ₋ₙ)}, Expression 2

The similarity calculating section 160 then calculates the similarities S(xₜ, xₜ₋ₙ) between the current timing and the plurality of past timings, using a suitable similarity function (e.g., the inverse of the distance) in which the smaller calculated distances d(xₜ, xₜ₋ₙ) result in larger similarities, for example.

At this time, the similarity calculating section 160 can weight the similarities, according to the differences between the current timing and the plurality of past timings. For example, the similarity calculating section 160 can weight the similarities using an attenuation coefficient that becomes larger at timings closer to the current timing and becomes smaller at timings farther from the current timing. In other words, the similarity calculating section 160 can weight the similarities by multiplying the similarities S (xₜ, xₜ₋₁₀) calculated for the timing T=t−10 by a coefficient that is relatively larger than the coefficient by which the similarities (xₜ, xₜ₋₁₀₀) calculated at the timing T=t−100 are multiplied, for example. In this way, the apparatus 100 can predict the value of the objective variable while giving more consideration to similarities calculated for timings closer to the current timing.

At step 330, the apparatus 100 predicts the value of the objective variable at a target timing, based on the similarities. At this time, the apparatus 100 can generate a predicted distribution of the value of the objective variable at the target timing.

The predicting section 170 acquires actual values of the 10-day return associated with the plurality of past timings and the similarities for the plurality of past timings, which were calculated by the similarity calculating section 160 in step 320, for example. Next, at step 332, the predicting section 170 generates a histogram of the similarities with respect to the actual values of the 10-day return at the plurality of past timings. The predicting section 170 then generates a predicted distribution of the 10-day return non-parametrically, using a kernel density estimation, for example, from the generated histogram of the 10-day return.

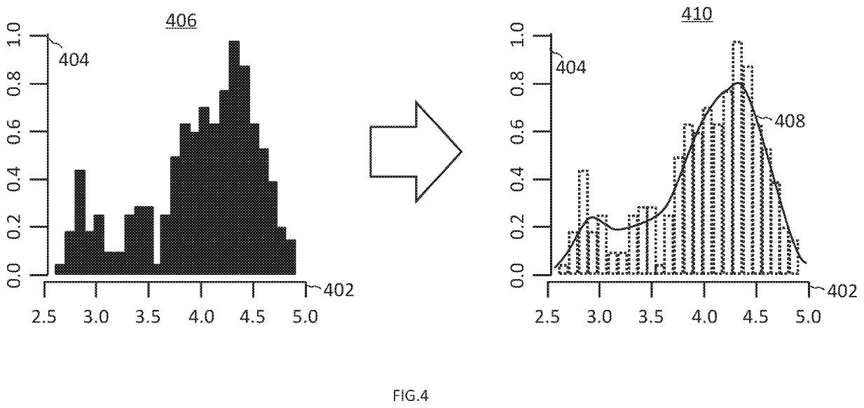

FIG. 4 shows examples of the predicted distribution and the histogram of the 10-day return generated by the apparatus 100 according to the present embodiment. In the present drawing, the horizontal axis 402 indicates the value of the 10-day return, and the vertical axis 404 indicates the degree of similarity. According to the flow shown in FIG. 2, the apparatus 100 can generate the histogram of the similarities with respect to the value of the 10-day return, as shown in chart 406, for example. The apparatus 100 can then generate the predicted distribution of the 10-day return indicating the possible values of the 10-day return and the probabilities of these values, as shown by the solid line 408 in chart 410, from the generated histogram of the 10-day return, by using the kernel density estimation that is a non-parametric method for estimating a probability density function, for example.

In this way, according to the apparatus 100 of the present embodiment, it is possible to predict the value of the objective variable corresponding to the current timing, based on past data. In other words, the apparatus 100 can predict, on the current day, the value of the return 10 days after the current day, based on the past data. Furthermore, when predicting the objective variable value, the apparatus 100 calculates the similarities between the current timing and the plurality of past timings using Mahalanobis' distances that take into consideration the relevance of each model with respect to the objective variable, and can therefore predict the value of the objective variable by selecting or combining the outputs of the plurality of models while taking into consideration the relevance of each model.

The above describes an example in which, when calculating the relevances, the apparatus 100 calculates the likelihood of the model given the objective variable at a plurality of predetermined timings, but the present embodiment is not limited to this. When calculating the relevances, the apparatus 100 can calculate the likelihood for only one timing, e.g., the timing T=t−10, and calculate the relevances based on this likelihood. In this way, the apparatus 100 can reduce the time and cost expended for the calculation of the relevances.

The above describes an example in which the apparatus 100 can weight the likelihoods and the similarities using an attenuation coefficient, but embodiments are not limited to this. For example, the apparatus 100 can weight only the likelihoods using the attenuation coefficient, while not weighting the similarities. In this way, the apparatus 100 can take into consideration the difference relative to the current timing for the relevances, without taking into consideration the difference relative to the current timing for the similarities. Similarly, the apparatus 100 can weight only the similarities using the attenuation coefficient, while not weighting the likelihoods. In this way, the apparatus 100 can take into consideration the difference relative to the current timing for the similarities, without taking into consideration the difference relative to the current timing for the relevances.

The above describes an example in which the apparatus 100 sets the first time period to be from the timing T=t−10 to the timing T=t−60 and sets the second time period to be from the timing T=t−10 to the timing T=1. In this way, the apparatus 100 can set the second time period to be longer than the first time period. In this way, the apparatus 100 can calculate the similarities based on the similarities accumulated over a relatively long time period in the past, while calculating the relevances based on data in a relatively short time period in the past. However, embodiments are not limited to this. The apparatus 100 can set the second time period and the first time period to have the same length, or can set the second time period to be shorter than the first time period.

The above describes an example in which the apparatus 100 stores each piece of data in day units and calculates the similarities between the current timing and the plurality of past timings in day units, but embodiments are not limited to this. The apparatus 100 can store each piece of data in different time units, and can calculate the similarities in these time units. Furthermore, the apparatus 100 can perform the calculation of the similarities in time units differing from the time units for which each piece of data is stored. In other words, the apparatus 100 can perform the calculation of the similarities based on statistics for a plurality of days, while storing each piece of data in day units. For example, the apparatus 100 can predict the value of the objective variable by calculating the similarities between statistics for a three-day period from the current day and statistics for three-day periods in the past.

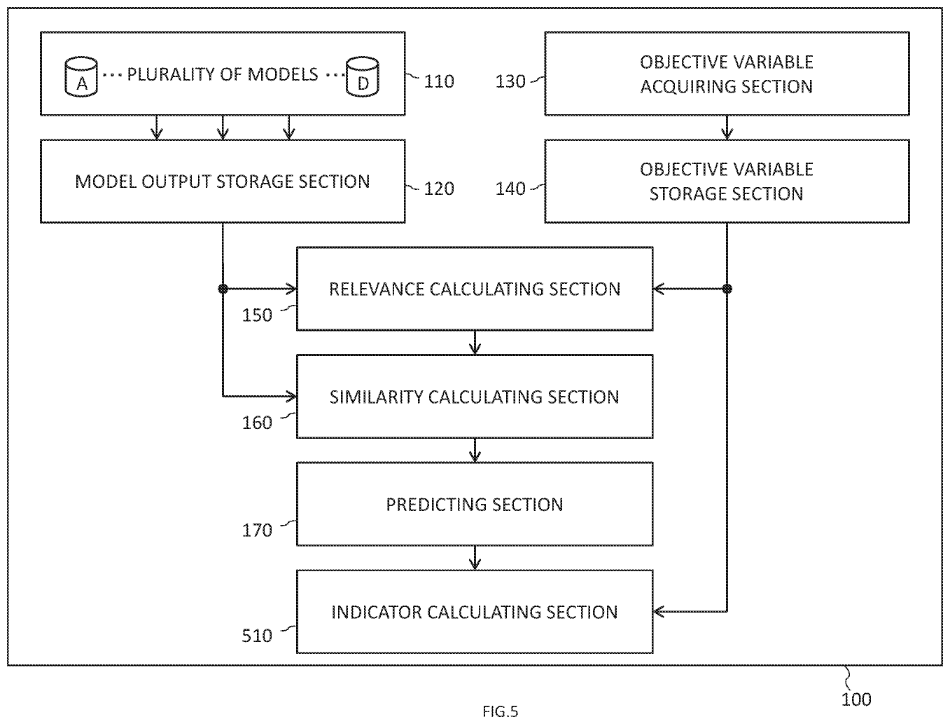

FIG. 5 shows an example of a block diagram of the apparatus 100 according to an embodiment. In FIG. 5, components that have the same function and configuration as components in FIG. 1 are given the same reference numerals, and the following description includes only differing points. The apparatus 100 of the present embodiment includes an indicator calculating section 510 in addition to the apparatus 100 shown in FIG. 1. The indicator calculating section 510 calculates an indicator of the predicted distribution of the value of the objective variable generated by the predicting section 170, with a distribution of the values of the objective variable at a plurality of past timings as a reference. At this time, the indicator calculating section 510 can calculate the indicator based on the difference between the generated predicted distribution and the distribution of the values of the objective variable at the plurality of past timings. The following describes this in detail, using a flow.

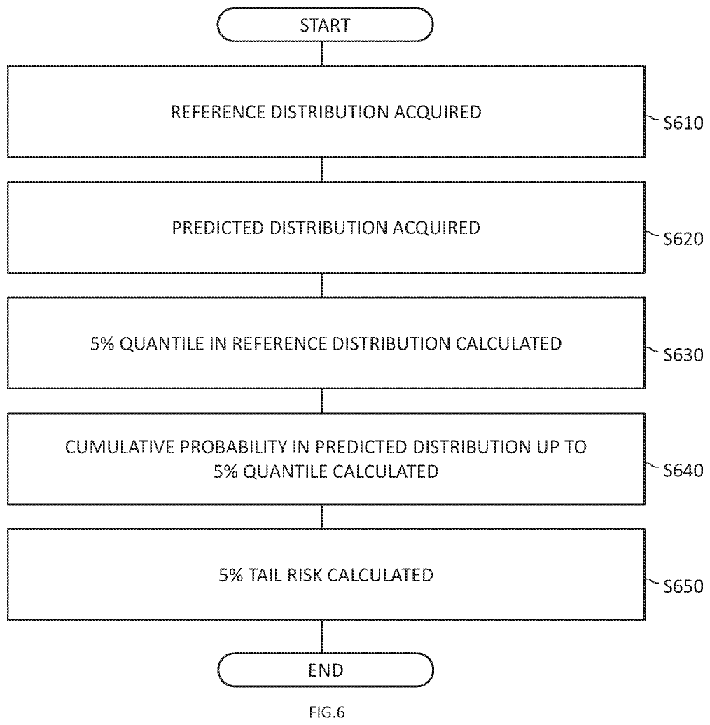

FIG. 6 shows an example of a flow by which the apparatus 100 according to the modification of the present embodiment calculates a 5% tail risk of the 10-day return, as an indicator of the generated predicted distribution of the value of the objective variable. At step 610, the apparatus 100 acquires a reference distribution to serve as a reference for the calculation of the indicator of the generated predicted distribution of the 10-day return. As an example, the indicator calculating section 510 acquires all of the past values of the 10-day return from the target variable storage section 140. The indicator calculating section 510 then acquires a probability distribution of all of the past 10-day returns, as the reference distribution, from all of the past values of the 10-day return.

At step 620, the apparatus 100 acquires the generated predicted distribution of the value of the objective variable, according to the flow shown in FIG. 3. As an example, the indicator calculating section 510 acquires the predicted distribution of the 10-day return generated by the predicting section 170 in step 332, from the predicting section 170.

At step 630, the apparatus 100 calculates the 5% quantile in the reference distribution. As an example, the indicator calculating section 510 calculates the 5% quantile at which the cumulative probability is 5%, by accumulating the probability of the values of the 10-day return in order from the smallest value in the probability distribution of all of the past 10-day returns acquired in step 610.

At step 640, the apparatus 100 calculates the cumulative probability in the predicted distribution up to the 5% quantile. As an example, the indicator calculating section 510 calculates the cumulative probability up to the 5% quantile by accumulating the probability up to the 5% quantile calculated in step 630, in order from the smallest 10-day return value, in the predicted distribution of the 10-day return acquired in step 620.

At step 650, the apparatus 100 calculates the 5% tail risk. As an example, the indicator calculating section 510 calculates the 5% tail risk by dividing the cumulative probability up to the 5% quantile calculated in step 640 by a value of 0.05 (5%) serving as a reference for the quantile.

In this way, the apparatus 100 according to the present modification can calculate the 5% tail risk as an indicator of the generated predicted distribution of the objective variable. This 5% tail risk is a value greater than or equal to 0, and a higher value indicates that the risk is greater. Furthermore, when the 5% tail risk is 1, this means that the generated predicted distribution has approximately the same risk as the reference distribution. Accordingly, by calculating the 5% tail risk, the apparatus 100 can calculate an indicator of risk for the predicted distribution of the 10-day return.

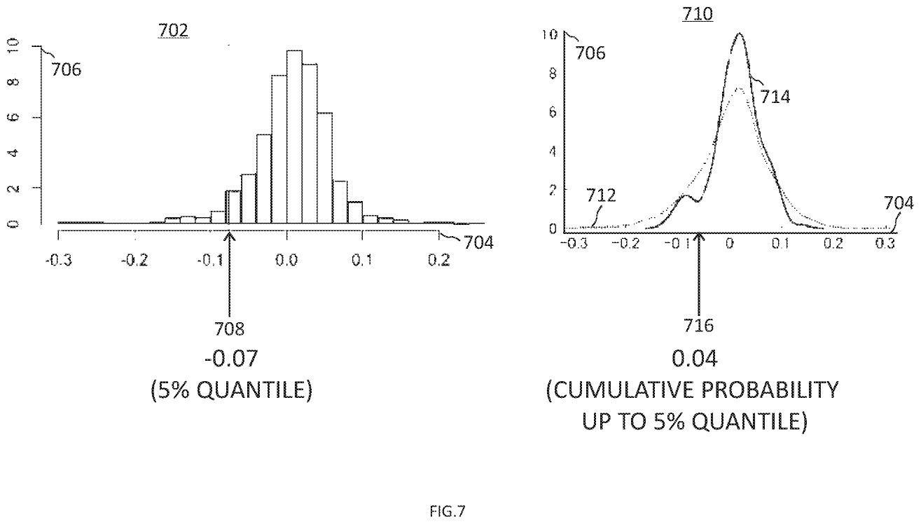

FIG. 7 shows examples of a reference distribution and a predicted distribution of the 10-day return generated by the apparatus 100 according to the modification of the present embodiment. In FIG. 7, the horizontal axis 704 indicates the value of the 10-day return, and the vertical axis 706 indicates the probability. According to the flow of FIG. 6, the apparatus 100 according to the modification of the present embodiment acquires statistics of all of the past 10-day returns, as shown in chart 702. The apparatus 100 then acquires the probability distributions of all past 10-day returns as the reference distribution, from the statistics of all of the past 10-day returns, as shown by the dotted line 712 in chart 710. Furthermore, the apparatus 100 acquires the predicted distribution of the 10-day return generated by the predicting section 170, as shown by the solid line 714 in chart 710.

Next, the apparatus 100 accumulates the probabilities in order from the smallest value of the 10-day return, in the probability distribution of all the past 10-day returns, to calculate the 5% quantile 708 at which the cumulative probability is 5% to be −0.07, for example. The apparatus 100 then accumulates the probabilities up to the 5% quantile, e.g., up to −0.07, in order from the smallest value of the 10-day return in the predicted distribution of the 10-day return, to calculate the cumulative probability up to the 5% quantile 716 to be 0.04, for example. Finally, the apparatus 100 calculates the 5% tail risk to be 0.8, by dividing the cumulative probability up to the 5% quantile 716, e.g., 0.04, by 0.05 (5%). In this case, since the 5% tail risk is less than 1, the apparatus 100 can judge that the generated predicted distribution of the 10-day return has a lower risk than the reference distribution of all of the past 10-day returns. In this way, according to the apparatus 100, it is possible to calculate an indicator of the generated predicted distribution of the value of the objective variable, with past distributions as a reference.

The above describes an example in which the apparatus 100 calculates the 5% tail risk as an indicator of the generated predicted distribution, but embodiments are not limited to this. For example, the apparatus 100 can calculate a tail risk with a different value, such as a 10% tail risk. Furthermore, the apparatus 100 calculates both the 5% quantile in the reference distribution and the 5% quantile in the predicted distribution, and calculates the tail risk indicator of the predicted distribution by comparing these 5% quantiles. Furthermore, instead of using the quantiles, the apparatus 100 can calculate a KL divergence, for example, as a difference between the reference distribution and the predicted distribution, and can calculate the predicted distribution indicator based on this KL divergence. As another example, the apparatus 100 can calculate the difference between the reference distribution and the predicted distribution from the average difference between the reference distribution and the predicted distribution, the dispersion difference between these distributions, the area of an overlapping portion between these distributions, or the like, and calculate the predicted distribution indicator based on this difference.

While embodiments of the present invention have been described with reference to financial models, such description is provided merely for simplifying the description of aspect of the present invention, and should be understood to in no way limit the present invention to financial models alone. Rather, embodiments of the present invention can employ models representing any real world environment, including speech and facial recognition, chemical, physical processes, healthcare, structural analysis, etc.

Various embodiments of the present invention can be described with reference to flowcharts and block diagrams whose blocks can represent (1) steps of processes in which operations are performed or (2) sections of apparatuses responsible for performing operations. Certain steps and sections can be implemented by dedicated circuitry, programmable circuitry supplied with computer-readable instructions stored on computer-readable media, and/or processors supplied with computer-readable instructions stored on computer-readable media. Dedicated circuitry can include digital and/or analog hardware circuits and can include integrated circuits (IC) and/or discrete circuits. Programmable circuitry can include reconfigurable hardware circuits including logical AND, OR, XOR, NAND, NOR, and other logical operations, flip-flops, registers, memory elements, etc., such as field-programmable gate arrays (FPGA), programmable logic arrays (PLA), etc.

The present invention can be a system, a method, and/or a computer program product. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to individualize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which includes one or more executable instructions for implementing the specified logical function(s). In some alternative implementations, the functions noted in the block can occur out of the order noted in the figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

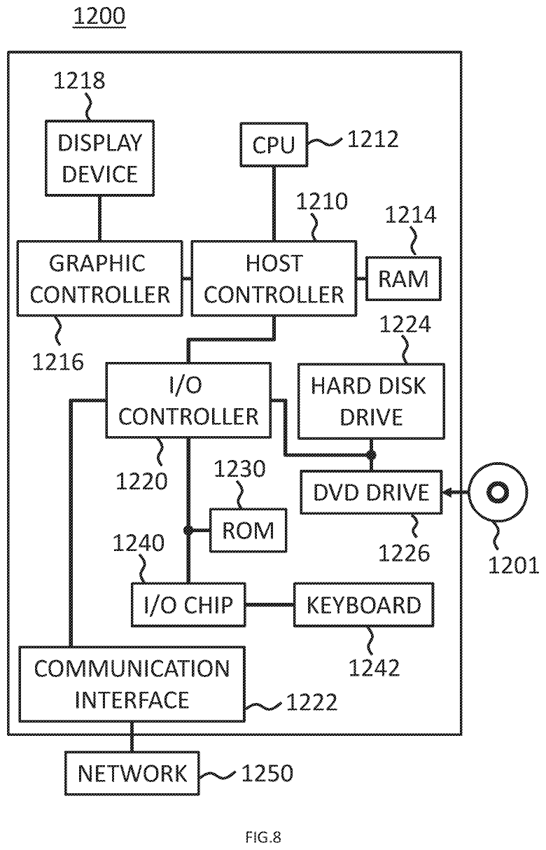

FIG. 8 shows an exemplary hardware configuration of a computer 1200 configured to perform the foregoing operations, according to an embodiment of the present invention. A program that is installed in the computer 1200 can cause the computer 1200 to function as or perform operations associated with apparatuses of the embodiments of the present invention or one or more sections (including modules, components, elements, etc.) thereof, and/or cause the computer 1200 to perform processes of the embodiments of the present invention or steps thereof. Such a program can be executed by the CPU 1212 to cause the computer 1200 to perform certain operations associated with some or all of the blocks of flowcharts and block diagrams described herein.

The computer 1200 according to the present embodiment includes a CPU 1212, a RAM 1214, a graphics controller 1216, and a display device 1218, which are mutually connected by a host controller 1210. The computer 1200 also includes input/output units such as a communication interface 1222, a hard disk drive 1224, a DVD-ROM drive 1226 and an IC card drive (not shown), which are connected to the host controller 1200 via an input/output controller 1220. The computer 1200 also includes legacy input/output units such as a ROM 1230 and a keyboard 1242, which are connected to the input/output controller 1220 through an input/output chip 1240.

The CPU 1212 operates according to programs stored in the ROM 1230 and the RAM 1214, thereby controlling each unit. The graphics controller 1216 obtains image data generated by the CPU 1212 on a frame buffer or the like provided in the RAM 1214 or in the graphic controller 1216 itself, and causes the image data to be displayed on the display device 1218.

The communication interface 1222 communicates with other electronic devices via a network 1250. The hard disk drive 1224 stores programs and data used by the CPU 1212 within the computer 1200. The DVD-ROM drive 1226 reads the programs or the data from the DVD-ROM 1201, and provides the hard disk drive 1224 with the programs or the data via the RAM 1214. The IC card drive (not shown) reads programs and data from an IC card, and/or writes programs and data into the IC card.

The ROM 1230 stores therein a boot program or the like executed by the computer 1200 at the time of activation, and/or a program depending on the hardware of the computer 1200. The input/output chip 1240 can also connect various input/output units via a parallel port, a serial port, a keyboard port, a mouse port, and the like to the input/output controller 1220.

A program is provided by computer readable media such as the DVD-ROM 1201 or the IC card. The program is read from the computer readable media, installed into the hard disk drive 1224, RAM 1214, or ROM 1230, which are also examples of computer readable media, and executed by the CPU 1212. The information processing described in these programs is read into the computer 1200, resulting in cooperation between a program and the above-mentioned various types of hardware resources. An apparatus or method can be constituted by realizing the operation or processing of information in accordance with the usage of the computer 1200.

For example, when communication is performed between the computer 1200 and an external device, the CPU 1212 can execute a communication program loaded onto the RAM 1214 to instruct communication processing to the communication interface 1222, based on the processing described in the communication program. The communication interface 1222, under control of the CPU 1212, reads transmission data stored on a transmission buffering region provided in a recording medium such as the RAM 1214, the hard disk drive 1224, the DVD-ROM 1201, or the IC card, and transmits the read transmission data to network 1250 or writes reception data received from network 1250 to a reception buffering region or the like provided on the recording medium.

In addition, the CPU 1212 can cause all or a necessary portion of a file or a database to be read into the RAM 1214, the file or the database having been stored in an external recording medium such as the hard disk drive 1224, the DVD-ROM drive 1226 (DVD-ROM 1201), the IC card, etc., and perform various types of processing on the data on the RAM 1214. The CPU 1212 can then write back the processed data to the external recording medium.

Various types of information, such as various types of programs, data, tables, and databases, can be stored in the recording medium to undergo information processing. The CPU 1212 can perform various types of processing on the data read from the RAM 1214, which includes various types of operations, processing of information, condition judging, conditional branch, unconditional branch, search/replace of information, etc., as described throughout this disclosure and designated by an instruction sequence of programs, and writes the result back to the RAM 1214. In addition, the CPU 1212 can search for information in a file, a database, etc., in the recording medium. For example, when a plurality of entries, each having an attribute value of a first attribute is associated with an attribute value of a second attribute, are stored in the recording medium, the CPU 1212 can search for an entry matching the condition whose attribute value of the first attribute is designated, from among the plurality of entries, and reads the attribute value of the second attribute stored in the entry, thereby obtaining the attribute value of the second attribute associated with the first attribute satisfying the predetermined condition.

The above-explained program or software modules can be stored in the computer readable media on or near the computer 1200. In addition, a recording medium, such as a network attached storage (NAS) unit, or a hard disk or RAM provided in a server system (not shown) that can be configured with similar hardware components as the computer 1200, connected to a dedicated communication network or the Internet can be used as the computer readable media, thereby providing the program to the computer 1200 via the network 1250.

The present invention can be a system, a method, and/or a computer program product. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to individualize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which includes one or more executable instructions for implementing the specified logical function(s). In some alternative implementations, the functions noted in the block can occur out of the order noted in the figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

Having described preferred embodiments of a system and method (which are intended to be illustrative and not limiting), it is noted that modifications and variations can be made by persons skilled in the art in light of the above teachings. It is therefore to be understood that changes can be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A computer-implemented method comprising:
calculating, for each of a plurality of models representing a, a relevance of an output of the model with respect to a value of an objective variable based on the value of the objective variable and the output of the model in the past;
calculating, for each of the plurality of models, similarities between a current timing and a plurality of past timings based on the output of the model at the current timing, the output of the model at the plurality of past timings, and the relevance;
predicting the value of the objective variable at a target timing based on the similarities; and
initiating an action responsive to the objective variable.

2. The computer-implemented method of claim 1, wherein the calculating the similarities includes, for each model, calculating the similarities based on distances between the output of the model at the current timing and the output of the model at the plurality of past timings.

3. The computer-implemented method of claim 2, wherein the distances are Mahalanobis' distances corresponding to the relevance.

4. The computer-implemented method of claim 1, wherein the calculating the relevance includes, for each model:
extracting a plurality of timings at which the output of the model is similar to the output of the model at a predetermined timing in the past;
calculating the likelihood of the model given a value of the objective variable at the predetermined timing, based on a distribution of values of the objective variable at the plurality of timings; and
calculating the relevance based on the likelihood.

5. The computer-implemented method of claim 4, wherein the calculating the relevance includes calculating the relevance based on an average of logarithm of the likelihoods of the model given the values of the objective variable calculated respectively for a plurality of the predetermined timings.

6. The computer-implemented method of claim 5, wherein the calculating the relevance includes weighting the logarithm of the likelihoods, according to differences between the current timing and the predetermined timings.

7. The computer-implemented method of claim 1, wherein the predicting the value of the objective variable includes generating a predicted distribution of the value of the objective variable at the target timing.

8. The computer-implemented method of claim 7, further comprising: calculating an indicator of the generated predicted distribution, using a distribution of the values of the objective variable at the plurality of past timings as a reference.

9. The computer-implemented method of claim 8, wherein the calculating the indicator includes calculating the indicator based on differences between distributions of the value of the objective variable at the plurality of past timings and the generated predicted distribution.

10. The computer-implemented method of claim 1, wherein the calculating the similarities includes weighting the similarities according to differences between the current timing and the plurality of past timings.

11. An apparatus comprising:
a processor or a programmable circuitry, and
one or more computer readable mediums collectively including instructions that, in response to being executed by the processor or the programmable circuitry, cause the processor or the programmable circuitry to:
calculate, for each of a plurality of models, a relevance of an output of the model with respect to a value of an objective variable, based on the value of the objective variable and the output of the model in the past;
calculate, for each of the plurality of models, similarities between a current timing and a plurality of past timings, based on the output of the model at the current timing, the output of the model at the plurality of past timings, and the relevance;
predict the value of the objective variable at a target timing, based on the similarities; and
initiating an action responsive to the objective variable.

12. The apparatus of claim 11, wherein the calculating the similarities includes, for each model, calculating the similarities based on distances between the output of the model at the current timing and the output of the model at the plurality of past timings.

13. The apparatus of claim 11, wherein the calculating the relevance includes, for each model:
extracting a plurality of timings at which the output of the model is similar to the output of the model at a predetermined timing in the past;
calculating the likelihood of the model given a value of the objective variable at the predetermined timing, based on a distribution of values of the objective variable at the plurality of timings; and
calculating the relevance based on the likelihood.

14. The apparatus of claim 11, wherein the predicting the value of the objective variable includes generating a predicted distribution of the value of the objective variable at the target timing.

15. The apparatus of claim 11, wherein the calculating the similarities includes weighting the similarities according to differences between the current timing and the plurality of past timings.

16. A computer program product including one or more computer readable storage mediums collectively storing program instructions that are executable by a processor or programmable circuitry to cause the processor or the programmable circuitry to perform operations comprising:
calculating, for each of a plurality of models, a relevance of an output of the model with respect to a value of an objective variable, based on the value of the objective variable and the output of the model in the past;
calculating, for each of the plurality of models, similarities between a current timing and a plurality of past timings, based on the output of the model at the current timing, the output of the model at the plurality of past timings, and the relevance;
predicting the value of the objective variable at a target timing, based on the similarities; and
initiating an action responsive to the objective variable.

17. The computer program product of claim 16, wherein the calculating the similarities includes, for each model, calculating the similarities based on distances between the output of the model at the current timing and the output of the model at the plurality of past timings.

18. The computer program product of claim 16, wherein the calculating the relevance includes, for each model:
extracting a plurality of timings at which the output of the model is similar to the output of the model at a predetermined timing in the past;
calculating the likelihood of the model given a value of the objective variable at the predetermined timing, based on a distribution of values of the objective variable at the plurality of timings; and
calculating the relevance based on the likelihood.

19. The computer program product of claim 16, wherein the predicting the value of the objective variable includes generating a predicted distribution of the value of the objective variable at the target timing.

20. The computer program product of claim 16, wherein the calculating the similarities includes weighting the similarities according to differences between the current timing and the plurality of past timings.
